(19) United States
(12) Patent Application Publication
(10) Pub. No.: US 2003/0229678 A1
(43) Pub. Date: Dec. 11, 2003

(54) System and method for processing wireless data

(76) Inventors: Say-Yee Wen, Taipei (TW); Shih-Li Wen, Taipei (TW); Hsiang-Min Liu, Taipei (TW); I-Ping Hu, Taipei (TW)

Correspondence Address: Mr. Ken Muncy, BIRCH, STEWART, KOLASCH & BIRCH, LLP, SUITE 500 EAST, 8110 GATEHOUSE ROAD, FALLS CHURCH, VA, 22042-1210, US

(21) Appl. No.: 10/401,767

(22) Filed: Mar. 31, 2003

(30) Foreign Application Priority Data
Jun. 10, 2002 (TW) 091112493

(51) Int. Cl. G06F 15/16

(52) U.S. Cl. 709/217

(57) ABSTRACT

A system and a method for processing wireless data are provided for use with products designated by bar codes. A customer can input a bar code of a product to an information center through telecommunication via an input interface of a portable electronic device such as cellular phone or personal digital assistant (PDA). Then, the information center transmits product information corresponding to the inputted bar code to a display interface e.g. screen of the portable electronic device, such that the customer can obtain the product information. This is therefore beneficially timesaving for allowing the customer to promptly acquire desirable information on products.

### FIELD OF THE INVENTION

The present invention relates to electronic commerce (e-commerce) information technology, and more particularly, to a system and a method for processing wireless data for allowing a customer to promptly obtain information related to a product assigned with a bar code through the use of a portable electronic device (such as a mobile phone or a personal digital assistant) having wireless communication ability.

### BACKGROUND OF THE INVENTION

Generally, a portable electronic device (such as a mobile phone or a personal digital assistant (PDA) having wireless communication ability is equipped with an online function (such as WEB or WAP), so as to enable a user to search information online related to the product or to search by key words for information such as restaurant information, relative geographical illustration, address and so on using the portable electronic device.

However, even though the conventional portable electronic device with wireless communication system is more convenient than the portable electronic device without online function, the user is still limited to searching only the desired product or restaurant information within the cyber world, without combing with an objective interface that is actually available. For example, if a consumer wishes to purchase a product in a store and wants to check if there is any cheaper price offered by other stores online, he/she needs to find out the name or brand name of the product before the product is searched online by the key words input using the portable electronic device. Therefore, information related to the product is not located immediately and a lot of time is wasted in the process of locating the information.

### SUMMARY OF THE INVENTION

An objective of the present invention is to provide a system and a method for processing wireless data, allowing consumers to obtain desired product related messages without wasting time on searching the product name.

Another objective of the present invention is to provide a system and a method for processing wireless data, allowing consumers to obtain information on the nearest store and/or cheapest store that sells the desired product.

In accordance with the foregoing and other objectives, the present invention proposes a system for processing wireless data. The system comprises at least a product having a bar code, a wireless transmission portable electronic device installed with a scanning module for scanning the bar code which is encoded into a wireless signal before transmitted, a telecommunication service end for receiving the wireless signal which is decoded into a bar code data and transmitted via a network system, and an information center which is stored with product information that corresponds to the bar code data. After the bar code data is received, the information center serves to retrieve the product information that corresponds to the product before transmitting back to the displaying interface of the wireless transmission portable electronic device.

According to another objective, the system for processing wireless data further comprises a mobile positioning module installed in the telecommunication service end for determining the position of the wireless transmission portable electronic device and sending the position to the information center. An address searching module and a product address database installed in the information center are provided for transmitting information of the nearest store and/or restaurant to the portable electronic device according to the position.

Based on the above system, a method for processing wireless data proposed in the present invention is applicable to a product assigned with a bar code. A customer can scan the bar code using a scanning module of a portable electronic device, such as mobile phone or personal digital assistance (PDA) before transmitting the bar code via a telecommunication service end to an information center having product information that corresponds to the bar code. The product information is then sent via the telecommunication service end to a displaying interface, such as monitor or sound output, so that the consumer can be informed of the related information of the desired product.

By comparing with the conventional art, the method of wireless processing data and system for the same are readily compatible with existing internet and wireless systems of wireless transmission portable electronic device (such as mobile phone). Therefore this solves problems associated with time wasted on searching product names or browsing through each web site to search for product information.

### BRIEF DESCRIPTION OF THE DRAWINGS

The present invention can be more fully understood by reading the following detailed description of the preferred embodiments, with reference made to the accompanying drawings, wherein:

FIG. 1 is a systemic diagram illustrating a basic structure of a system for processing wireless data according to a preferred embodiment of the invention;

FIG. 2 is a flow chart illustrating a method for processing wireless data according to the invention;

FIG. 3 is a flow chart illustrating details of step S1 shown in FIG. 2; and

FIG. 4 is a systemic diagram illustrating a basic structure of the system for processing wireless data according to another preferred embodiment of the present invention.

### DETAILED DESCRIPTION OF THE PREFERRED EMBODIMENTS

The preferred embodiment of the method for processing wireless data and system for the same are described below with reference to the attached figures.

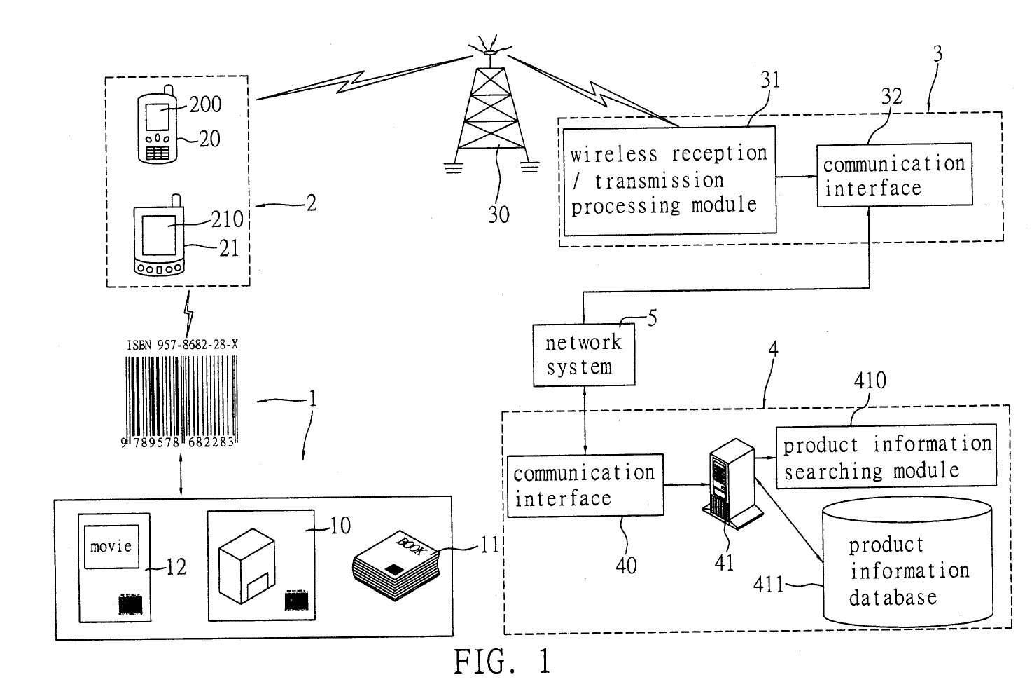

As shown in FIG. 1, the system for processing wireless data comprises at least a product 1 having a bar code, a wireless transmission portable electronic device 2, a telecommunication service end 3, and an information center 4.

The product 1 having the bar code, besides being a product displayed on a display shelf or a vending product, can also be sales related information from an advertisement pamphlet or magazine, for example, information such as restaurant 10, fashion, housing, travel, books 11, movies 12, and so on. The bar code may be made up of conventional two-dimension (2D) numbers.

The wireless transmission portable electronic device 2 (such as mobile phone 20 or personal digital assistant (PDA 21) comes with a scanning module (not shown) for scanning the bar code and encoding it into a wireless signal that is then transmitted.

The telecommunication service end (such as a telecommunication company) 3 comprises a cell 30, a wireless reception/transmission process module 31, and a communication interface 32, wherein the cell 30 serves to receive and process the wireless signal before being transmitted (since the technique involved is well known to one skilled in the pertinent art, the detail is omitted herein).

The communication interface 32 is connected to the wireless reception/transmission process module 31, so as to receive the bar code data, which is then processed before being transmitted to the network system 5 (such as Internet or Intranet).

The information center 4 (such as Internet service provider (ISP), telecommunication service provider, or merchandiser) comprises at least a communication interface 40 connected to the network system 5, a web server 41 for receiving the bar code data via the communication interface 40, where the web server 41 has a product information searching module 410 and a product information database 411. The product information searching module 410 serves to receive the bar code data and to search the product information database 411 for product information that corresponds to the bar code data before transmitting back to the telecommunication service end 3, where the product information is then transmitted to a display interface of the wireless transmission portable electronic device 2 (such as monitors 200, 210 of the mobile phone 20 and PDA 21, respectively).

In operation, the merchandiser needs to establish the product information database 411 (including recommendation for restaurants, information on dining/reservation, fashion clothing, housing, travel, books, movies, and so on) in the information center 4 of the web server 41. After the bar codes are acquired, the bar codes are assigned to appropriate positions for the products 10, 11, and 12. So, when the user wishes to know the information related to the products 10, 11 and 12, the user can scan and process the bar code via the wireless transmission portable electronic device 2 into a wireless signal before transmitting the wireless signal online. Then, via the cell 30, the signal is transmitted to the telecommunication service end 3 where the signal is processed into a bar code data before the bar code data is transmitted to the web server 41 of the information center 4. Next, the product information searching module 410 of the server 41 enters the product information database 411 to transmit the product information that corresponds to the bar code back to display interface (such as the monitors 200, 210 of the mobile phone 20 and PDA 21, respectively). As a result, the user can be informed instantly of the information related to the desired product through data (word, sound, or image) displayed in the display interface.

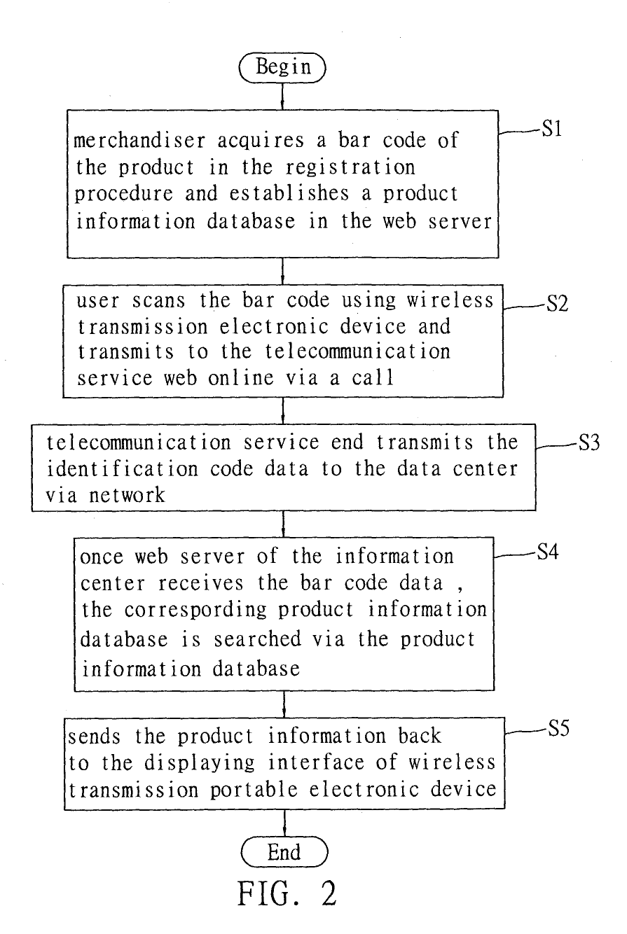

FIG. 2 is a flow chart illustrating a method for processing wireless data according to the preferred embodiment of the present invention.

As shown in FIG. 2, in step S1, the merchandiser acquires the bar code of a product via a registration procedure and establishes the product information database in the web server of the information center. The process then goes on to step S2.

In step S2, the user scans the bar code using the wireless transmission portable electronic device. Then the user is connected to Internet (for example, WEB or WAP) so that after the bar code is encoded into a wireless signal comprising the bar code, it is transmitted via base stations to the telecommunication service end 3 (such telecommunication company). Then, the process goes on to step S3.

In step S3, the wireless reception/transmission process module 31 of the telecommunication service end 3 receives the wireless signal comprising the bar code identification. Next, the signal is decoded into a bar code data which is transmitted via the communication interface to the network system before further transmitted via the network system to the information center 4. The process then goes on to step S4.

In step S4, after the web server 41 of the information center 4, receives the bar code data, the product information database 411 is searched via the product information searching module for product information 410 that corresponds to the bar code data. The process then goes on to step S5.

In step S5, the product information in the product information database 411 is transmitted to the telecommunication service end 3, and with the wireless reception/transmission process module 31, the product information is transmitted to the display interface of the wireless transmission portable electronic device 2, so as to complete searching of product information by scanning in one time.

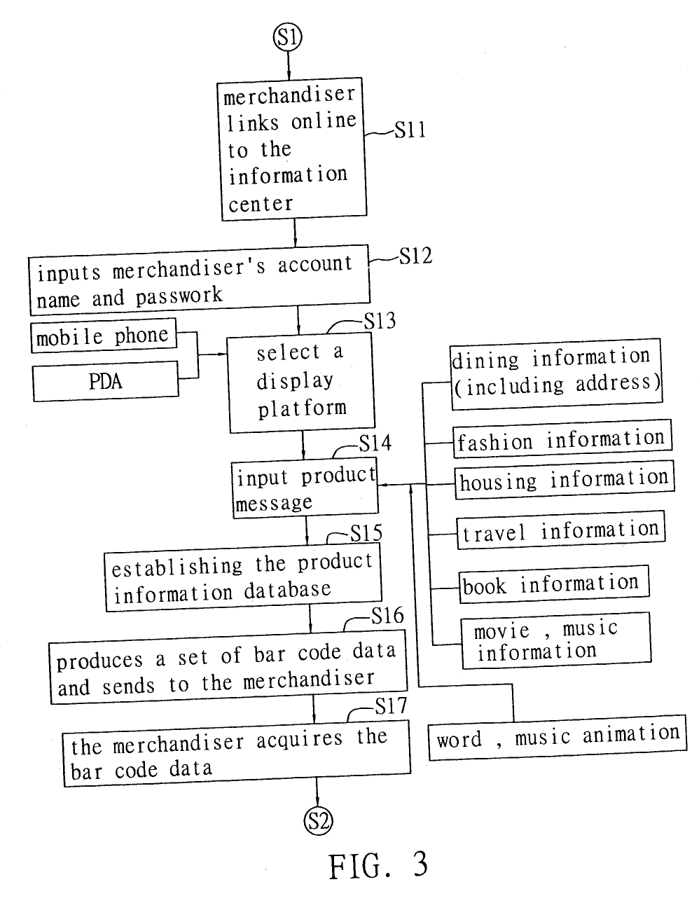

FIG. 3 is a flow chart illustrating the details of step S1 as described in FIG. 2.

As shown in FIG. 3, in step S11, the merchandiser is connected to the web server 41 of the information center 4 by wire (such as modem dial-up or ADSL cable) or in a wireless manner (such as Infrared Data Association (IrDA) wireless communication protocol, or Bluetooth wireless communication protocol).

In steps S12 and S13, after the account name and the password are inputted by the merchandiser and are verified by the web server, the web server is available to the merchandiser to choose the electronic platforms (for example, mobile phone, PDA and so on) to be displayed.

In step S14, the merchandiser inputs the product information in word, music and/or animated formats. For example, the restaurant information (including address of the restaurant, map, menu, price, reservation service, and so on), fashion clothing information (including a nearest shopping spot, price comparison, order, delivery, and so on), housing information (including rental, mortgage, sale information, and so on), travel information (including oversea and domestic travel fare, hotel reservation, and so on), new car information (including comparison of a variety of cars from domestic to foreign selections, prices, agent information, and so on), and books or movies information (including name of showing movies, different time schedules, reservation service, and so on) are inputted.

In step S15, as long as the information center receives the input information, the information is established in the product information database.

In steps S16 and S17, a set of bar code data that corresponds to the product is produced after the database is established, and the data is sent back to the merchandiser to complete the registration procedure.

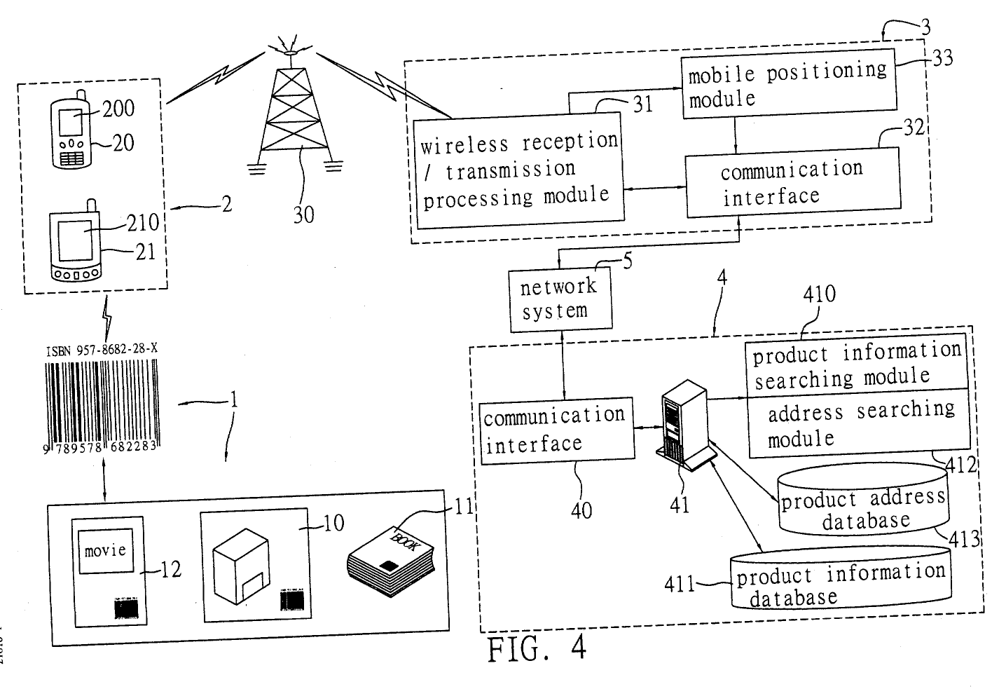

FIG. 4 is a systemic diagram illustrating the basic structure of the system for processing wireless data according to another preferred embodiment of the present invention. Besides the basic structure that includes the product with a bar code, the wireless transmission portable electronic device 2, the telecommunication service end 3, and the information center 4, the system is characterized by having a mobile positioning module 33 installed in the telecommunication service end 3 and further establishing an address searching module 412 and a product address database 413 in the web server 41 of the information center 4. So, when the wireless signal is transmitted by the wireless transmission portable electronic device 2, the position of the wireless signal transmission portable electronic device 2 can be identified and transmitted to the web server 41 of the information center 4. Then, the web server 41 would search via the address searching module 412 for the data in the product address database 413. The merchandiser and data that correspond to the product are then sent back to the displaying interface of the wireless transmission portable electronic device 2 (such as monitors 200, 201 of the mobile phone 20 and PDA 21, respectively. As a result, the user can be informed of the information related to the price of the product and the nearest store that sells the product.

In conclusion, the present invention provides a system for processing wireless data and method for the same, so that the consumer can search for product information by scanning the bar code of the product with the scanning module of the portable information device and upload to the information center to obtain the product information. By comparing with the conventional art, the invention combines a real interface and cyber space together to enable the consumer to search for required information without entering passwords, key words, or spending time on searching the product name or restaurant name. And with the mobile address searching module, the position of the user can be located, while the location of the nearest merchandiser and data can be provided. Thus, this solves the problem encountered with the conventional art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A system for processing wireless data, comprising:
a source of bar code for identifying a product;
a wireless transmission portable electronic device having a display interface and a scanning module, wherein the scanning module scans and encodes the bar code into a wireless signal;
a telecommunication service end for receiving the wireless signal from the scanning module and decoding the wireless signal into the bar code that is transmitted via a network system; and
an information center having a product information database stored with bar codes of products and product information corresponding to the bar codes, wherein the information center obtains product information from the product information database corresponding to the bar code being transmitted from the telecommunication service end to the information center, and forwards the obtained product information via the network system to the telecommunication service end and then to the wireless transmission portable electronic device where the product information is displayed on the display interface and accessible for users.

2. The system of claim 1, wherein the telecommunication service end comprises:
a cell for receiving and processing the wireless signal from the scanning module and for transmitting the processed wireless signal;
a wireless reception/transmission process module for receiving the wireless signal from the cell and decoding the wireless signal into the bar code and for transmitting the bar code; and
a communication interface for receiving and processing the bar code from the wireless reception/transmission process module and for transmitting the processed bar code to the network system that forwards the bar code to the information center.

3. The system of claim 1, wherein the information center comprises:
a communication interface for receiving the bar code from the network system; and
a web server having a product information search module and the product information database, wherein the product information search module receives the bar code from the communication interface and obtains the corresponding product information from the product information database to transmit the obtained product information to the telecommunication service end.

4. The system of claim 1, wherein the portable electronic device is a mobile phone.

5. The system of claim 1, wherein the portable electronic device is a personal digital assistant (PDA).

6. The system of claim 1, wherein the telecommunication service end is a telecommunication company.

7. The system of claim 1, wherein the information center is selected from the group consisting of Internet service provider (ISP), telecommunication service provider, and commercial firm.

8. The system of claim 1, wherein the telecommunication service end further comprises a mobile positioning module for locating the wireless transmission portable electronic device according to the wireless signal emitted from the portable electronic device.

9. The system of claim 8, wherein the information center further comprises an address searching module and a product address database, whereby the information center receives the location of the portable electronic device from the telecommunication service end, and the address searching module searches related information of product sale addresses from the product address database relatively closer to the location of the portable electronic device and transmits the searched address information to the portable electronic device where the searched information is displayed on the display interface.

10. A method for processing wireless data, comprising the steps of:
establishing a product information database stored with at least product information and bar codes of products corresponding to the product information;
scanning a bar code via a scanning module of a wireless transmission portable electronic device and transmitting a wireless signal encoded from the bar code via the portable electronic device; and
receiving the wireless signal via a telecommunication service end and decoding the wireless signal into the bar code that is transmitted to an information center where product information is searched from the product information database corresponding to the bar code and the searched product information is transmitted to an output interface of the portable electronic device.

11. The method of claim 10, wherein the step of establishing the product information database comprises the procedures of:
establishing an online connection from an information builder to a server of the information center;
inputting the product information via the information builder to the server of the information center to build the product information database; and
generating a set of bar codes corresponding to the product information and transmitting the bar codes to the information builder via the server of the information center.

12. The method of claim 10, wherein a wireless reception/transmission process module of the telecommunication service end receives the wireless signal and decodes the wireless signal into the bar code that is transmitted via a communication interface to the server of the information center having the product information database.

13. The method of claim 12, wherein a product information search module of the server of the information center searches the corresponding product information from the product information database when the bar code is received by the server of the information center.
